(19) United States
(12) Patent Application Publication
(10) Pub. No.: US 2005/0072204 A1
(43) Pub. Date: Apr. 7, 2005

(54) Tolerance ring manufacturing process and apparatus

(76) Inventors: Neal Maze, Palm Desert, CA (US); David A. Janes, Newport Beach, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/963,823

(22) Filed: Sep. 30, 2004

Related U.S. Application Data
(60) Provisional application No. 60/507,883, filed on Oct. 1, 2003.

(51) Int. Cl. B25C 1/08; B21D 5/08

(52) U.S. Cl. 72/374; 72/176

(57) ABSTRACT

Disclosed is a process and method for forming tolerance rings. The process preferably is accomplished in a fully automated manner not requiring the manipulation of the product by human hands. The process preferably uses a fourslide tooling device and an assembly of pins to form a tolerance ring. The fourslide preferably is comprised of upper and lower tool sets for manipulating a flat strip of stock into a tolerance ring having overlapping ends and a plurality of dimple and/or bumps. Preferably the tolerance ring is formed without having to move a partially compressed tolerance ring from a first machine to a second machine.

### RELATED APPLICATION

This application claims priority to provisional application Ser. No. 60/507,883, filed Oct. 1, 2003, the entirety of which is hereby incorporated by reference.

### BACKGROUND OF THE INVENTION

1. Field of the Invention

The field relates to systems for forming manufacturing components. More specifically, the field is directed to the processing of tolerance rings for use in mechanical devices such as computer disk drives.

2. Description of the Related Art

Technology is a constantly changing field wherein processes are becoming faster and parts are becoming smaller. In all fields ranging from automobiles to computers, manufacturing companies increasingly rely on automated improvements to increase the throughput of their production processes. Current processes often involve time consuming procedures that slow the manufacturing of products and therefore result in a decline in the company's potential profit margins. Further, time consuming processes may involve unnecessary company expenditure of labor and machinery. For example, a production process may require a product to be transferred from one machine to a second machine for final preparation of the product. Such a system necessarily involves extra floor space for the second machine and an employee to move the product from the first machine to the next. Depending on the particular process, other potential drains to the company may exist: added power may be consumed by extra machines and downtime in the manufacturing process can be caused by required maintenance.

### SUMMARY OF THE INVENTION

Briefly stated, embodiments of the invention are directed towards a process and apparatus for producing formed metal objects in an improved and efficient manner. More specifically, in one embodiment, tolerance rings are produced through a process which lacks the need to manually alter the position of the tolerance ring during the manufacturing process. In other embodiments, the process uses a single machine to perform the entire manufacturing process. Preferably, the process uses a fourslide machine arranged in a stacked manner whereby partially completed products are transferred from an upper tool system to a lower tool system through the use of ejector pins and a nesting device.

In one embodiment, a method of making a metallic ring is provided. This method comprises inserting a strip of metal into a first portion of a machine. In the first portion, the strip is shaped around a first pin having a first diameter. After shaping the strip around the first pin, the strip of metal is moved automatically into a second portion of the machine. In the second portion, the strip of metal is shaped around a second pin having a second diameter smaller than the first diameter. After shaping the strip around the second pin, the ring may be released from the machine.

Preferably, in this method, the second portion is below the first portion. The strip of metal may be automatically moved from the first portion to the second portion by sliding the strip down the first pin having a first diameter. The strip may be shaped around the pins of each portion by sliding components that press the strip between surfaces of the sliding components and the pin. The sliding components may be found in a fourslide device. In another embodiment, a machine is provided that performs the method described above.

In anther embodiment, a method for manufacturing a tolerance ring is provided. A piece of metal stock is placed having two ends adjacent a concave surface of a front cradle of an upper tool set. The front cradle is moved in the direction of a back cradle so that the metal stock at least partially compresses around a large pin, the large pin being located intermediate the front cradle and the back cradle in the upper tool set. The back cradle is moved in the direction of the front cradle such that a substantially tight fit is formed between the front cradle and back cradle, wherein the metal stock is compressed around the large pin, the piece of metal stock being formed into an at least partially compressed state. Compression is released around the large pin by moving the back cradle and front cradle in opposite directions to their original positions, while simultaneously a pressure pin makes contact with the piece of metal stock and maintains the metal stock in a fixed location on the large pin. A left nesting slide and a right nesting slide are moved in a direction approximately perpendicular to the direction traversed by the front cradle and back cradle, such that the left nesting slide and right nesting slide contact each other and close to form a nest at a vertical level below the level of the location of the upper tool set. The pressure pin is retracted from the metal stock and the large pin. The partially compressed stock is moved vertically downward, by use of ejectors, and into the nest below formed by the left nesting slide and the right nesting slide. A front tightener and a back tightener, of a lower tool set, are moved towards each other to come in contact with the partially compressed stock. The partially compressed stock is compressed, by use of the front tightener and the back tightener, around a relatively smaller pin than the large pin, the smaller pin connected to the back tightener, such that the partially compressed stock is compressed to a fully compressed state, wherein the two ends of the fully compressed stock partially overlap to form a complete circular shape. The smaller pin is moved in a horizontal direction away from the front tightener. The fully compressed stock is dropped from the small pin to a receptacle located below the lower tool set.

In another embodiment, a method of forming a stock material is provided. A front cradle and a back cradle of a first tool set are moved to compress a piece of stock material around a large pin, the large pin located intermediate the front cradle and the back cradle, wherein the stock material forms an at least partially circular shape and is in a partially compressed state. The partially compressed stock automatically moves to a location between a front tightener and a back tightener of a second tool set. The partially compressed stock is compressed around a small pin with the front and back tighteners, the stock material forming a complete circular shape and being in a fully compressed state. The fully compressed stock is released from the small pin.

In another embodiment, an apparatus for forming a piece of material is provided. An upper tool set, movable in a horizontal forward and backward direction, comprises a front cradle and a back cradle adapted to compress the piece of material around a large pin. A nest, movable in a horizontal left and right direction, comprises a left nesting slide and a right nesting slide, wherein the nest is located at a vertical level below the upper tool set. A lower tool set, movable in a horizontal forward and backward direction, comprises a front tightener and a back tightener, wherein the lower tool set is at a vertical level below the nest and the nesting slides are approximately perpendicular to the lower tool set, wherein the front and back tighteners are adapted to compress around a small pin, the small pin being smaller than the large pin.

### BRIEF DESCRIPTION OF THE DRAWINGS

FIG. 1 is a schematic view from overhead of an embodiment of the upper or top cradle tools.

FIG. 2 is a schematic view of an embodiment of a stock unit after it is shaped by the front cradle around a large pin.

FIG. 3 is a schematic side view of the embodiment of FIG. 1.

FIG. 4 is a schematic view from overhead of the upper or top cradle tools with the nesting slides in position to hold a partially formed tolerance ring.

FIG. 5 is a schematic view from overhead view of an embodiment of the lower or bottom cradle tools.

FIG. 6 is a schematic side view of the embodiment of FIG. 5.

FIG. 7 is a schematic view from overhead of an embodiment of the upper or top cradle tools, nesting slides, and lower cradle tools.

FIG. 8 is a schematic side view of the embodiment of FIG. 7.

FIG. 9 is a schematic view from overhead of the nesting slides.

FIG. 10 is a schematic side view of the nesting slides and the large pin.

FIG. 11 is a schematic view from overhead of an embodiment of the large pin and ejectors.

FIG. 12 is a schematic side view of the embodiment of FIG. 11.

### DETAILED DESCRIPTION OF THE PREFERRED EMBODIMENTS

Embodiments of the invention are directed towards forming manufacturing parts in a quick and efficient manner. The systems and procedures employed here may apply to a variety of shapes and materials. One of the embodiments is directed to forming tolerance rings; however, the invention can be used to form a variety of parts. Generally, the embodiments described below will be used for objects composed of metal; however, it is understood that the invention may be used with any suitable materials that may be readily transformed from one configuration to another.

Tolerance rings are generally circular ring-like structures formed from a metal stock unit. In order to form a tolerance ring, the metal stock is rolled to a precise radial measurement so that it may perform in its corresponding mechanical and/or electrical component. For example, tolerance rings may be used in disk drives or automotive parts. Tolerance rings may be substantially circular strips of metal with a plurality of dimple and/or bumps located thereon. It will be appreciated that other types of parts may be formed in addition to tolerance rings. Preferably the apparatus and the process may be best understood with reference to the accompanying figures.

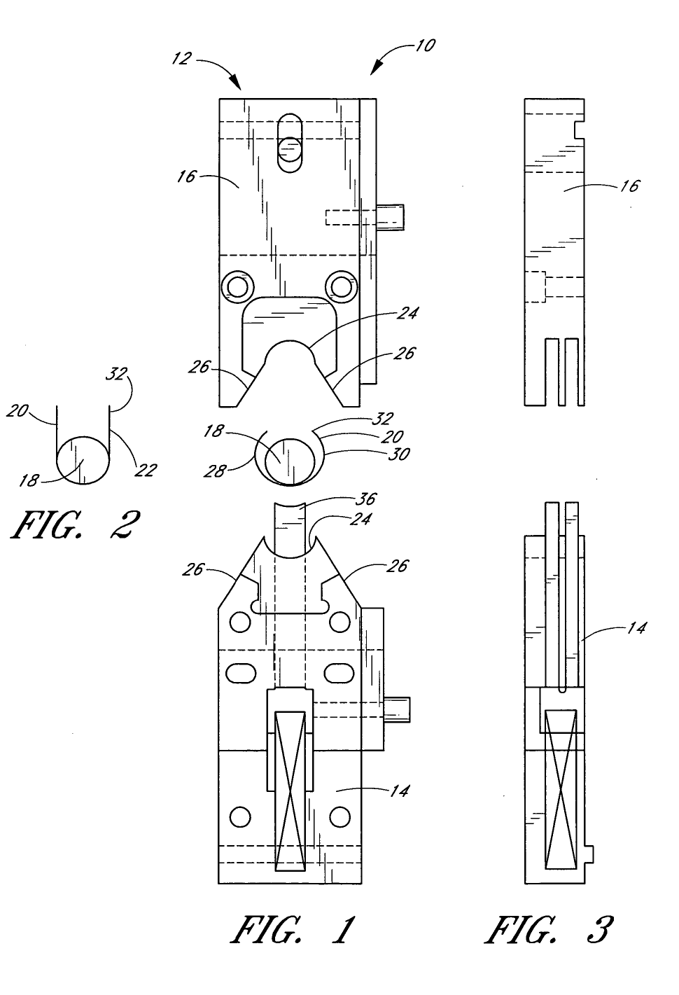

FIG. 1 is an overhead view of the upper tool set 12 of an embodiment of a fourslide device 10. The upper tool set 12 is comprised of a front cradle 14 and a back cradle 16. Between the two cradles 14, 16 lies a large pin 18 for shaping the stock 20. Preferably a plurality of bumps and/or dimples (not shown) is formed on the stock 20 before the stock 20 enters the fourslide device 10. The stock 20 may be composed of various shapes but for exemplifying purposes, the stock 20 discussed herein is a rectangular strip. The large pin 18 of the embodiment is shown to be generally circular. The large pin 18 may have various alternative cross-sectional shapes including but not limited to geometric configurations. Further, the large pin 18 of the embodiment shown has a substantially smooth surface. In other embodiments, it may be preferable for the large pin 18 to have a pattern located thereon to add shape to the stock 20 upon compression around the large pin 18. For example, in some embodiments, the large pin 18 may have a plurality of dimples or bumps located thereon.

With continued reference to FIG. 1, the front cradle 14 moves the stock 20 around the large pin 18 to give it a substantially U-shaped 22 structure (as shown in FIG. 2). The front cradle 14 has a generally concave surface 24 substantially corresponding to the curvature of the large pin 18. The concave surface 24 of the front cradle 14 further contains two adjacent edges 26 that are substantially straight. The concave surface 24 of the front cradle 14 is generally smooth in the disclosed embodiment, however, like the large pin 18, may have a pattern located thereon to further add shape to the stock 20 upon compression around the large pin 18. In some embodiments, the concave surface 24 is smooth while only the large pin 18 has a pattern. Likewise, in other embodiments, the large pin 18 may have a smooth surface while the concave surface 24 has a pattern located thereon. Further, both the large pin 18 and the concave surface 24 may have patterns located thereon.

After the front cradle 14 has compressed the stock 20 around the large pin 18, the back cradle 16 closes to form a tight fit with the large pin 18 and the front cradle 14. The back cradle 16 and the front cradle 14 compress the stock 20 around the large pin 18 to give the stock 20 a shape generally matching that of the accompanying large pin 18. In some embodiments, the back cradle 16 may begin to move towards the large pin 18 simultaneously with the front cradle 14. In other embodiments, the back cradle 16 may move towards the large pin 18 before the front cradle 14 begins to move. Still, in other embodiments, one or more of the cradles 14, 16 may remain stationary while the large pin 18 moves the stock 20 to and from the cradles 14, 16. The back cradle 16 of the disclosed embodiment has a concave upper surface 24 generally matching the shape of the large pin 18. The back cradle 16 has straight edges 26 lying adjacent to the upper concave surface 24, which are configured to receive the straight edges 26 of the front cradle 14. Upon compression of the stock 20 around the large pin 18 by both cradles 14, 16, the stock 20 thereafter obtains a shape similar to that of the large pin 18. The cradles 14, 16 later retract from the large pin 18 to their original positions. Subsequently, due to the natural elasticity of the stock 20, the stock 20 may expand to form a shape having a larger diameter than that of the large pin 18.

The diameter of stock 20 is meant to refer to the measurement of one location 28 on the stock 20 to a location 30 directly opposite the first location 28. The term diameter is generally meant to have the same definition as would be normally applied to a circle. The same basis for measuring points should likewise apply here even though the partially compressed stock 20 may not form a complete circle. Here, the stock 20 assumes a shape such that no overlap between ends 32 of the stock 20 exists. In other embodiments the partially compressed state may have the ends 32 of the stock 20 touching. In other embodiments, the ends 32 may overlap each other in the partially compressed state.

In one embodiment, it is preferred that the cradles 14, 16 compress the large pin 18 at a force of about 19-90 lbs. per square inch. In a preferred embodiment, the amount of pressure exerted is measured at about 50 lbs. per square inch. In the embodiments in which one or more of the cradles 14, 16 remain stationary, the large pin 18 retracts to its original position and away from the cradles 14, 16 to allow the stock 20 to relax to its partially compressed state.

FIG. 3 shows a side view of FIG. 1. After the two cradles 14, 16 compress the stock 20 around the large pin 18, the cradles 14, 16 return to their original retracted positions. Upon release by the cradles 14, 16, the stock 20 may partially spring back to its original position due to the internal tension of the stock 20. A pressure pin 36 may be located on the front cradle 14 to hold the stock 20 against the large pin 18 in a substantially fixed manner. The pressure pin 36 ensures that the stock 20 retains its new shape while waiting to move to the next step in one embodiment of the process. The pressure pin 36 may be retracted to release the stock 20.

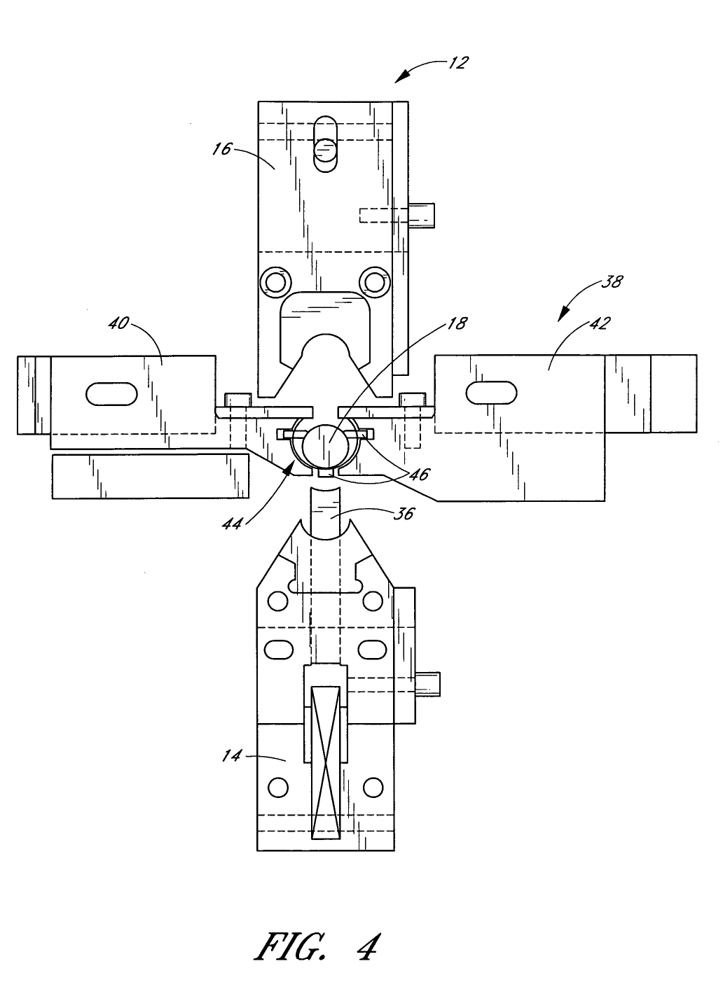

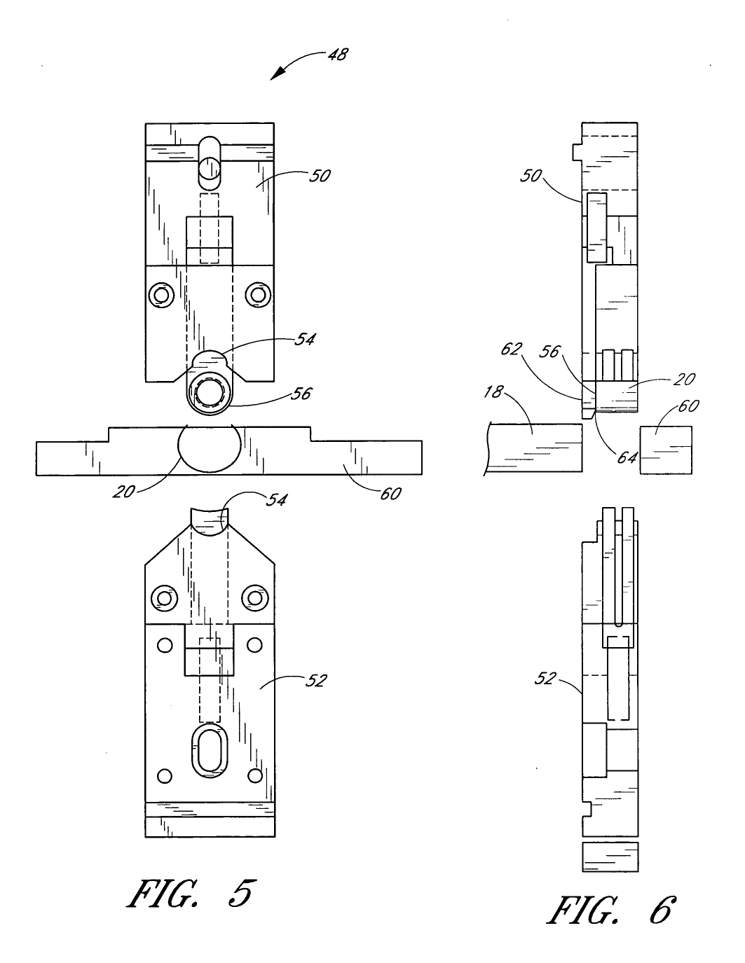

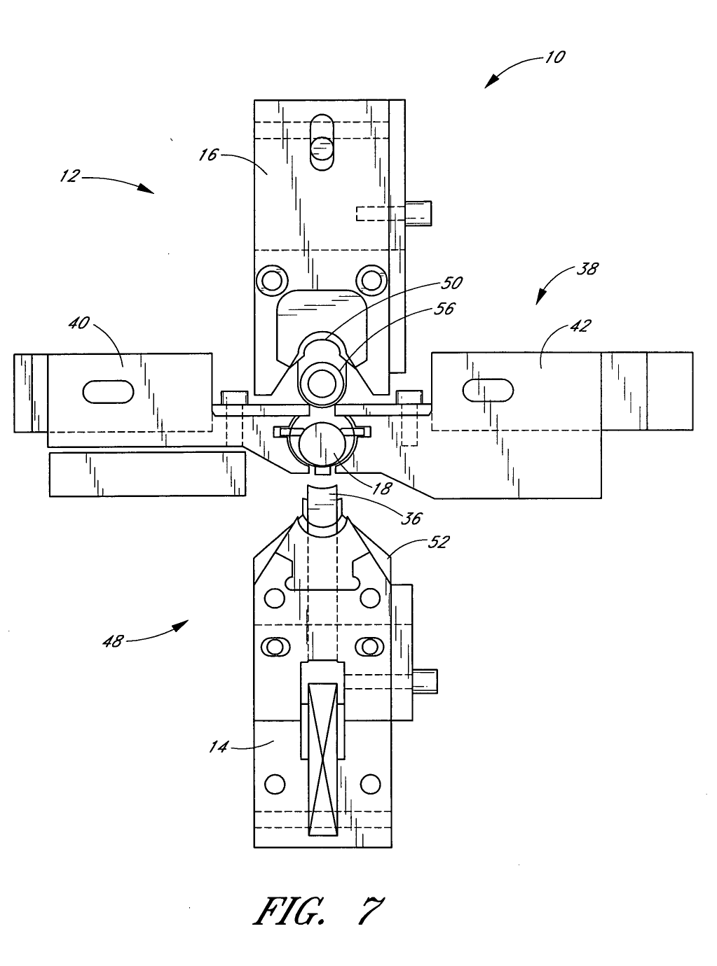

FIG. 4 shows a nesting level 38. The nesting level 38 is composed of a left slide 40 and right slide 42. The nesting level 38 is generally located beneath the upper or top tool set 12. When the cradles 14, 16 and pressure pin 36 retract, a pair of slides 40, 42 move into place to receive the partially compressed stock 20. The left slide 40 and right slide 42 close to form a nest 44 for the partially compressed stock 20. Upon release of the partially compressed stock 20 by the cradles 14, 16 and pressure pin 36, one or more ejectors 46 may push the partially compressed stock 20 off of the large pin 18 and into the nest 44. The ejectors, with three shown in the illustrated embodiment, may be metal strips provided as part of the upper tool set that slide along the surface of the large pin. Upon retraction of the cradles 14, 16, the partially compressed stock 20 thereafter descends down the length of the large pin 18 and into the nest 44 waiting below. The nest 44 temporarily holds the partially compressed stock 20 before the lower or bottom tool set 48 moves into place. (Shown in FIGS. 5-6).

FIG. 5 is a top view of the lower tool set 48. The lower tool set 48 is composed of a back tightener 50 and a front tightener 52. The tighteners 50, 52 resemble the configuration of the cradles 14, 16 of the upper tool set 12. The tighteners 50, 52 of the embodiment generally differ from the upper tool set 12 in that they each have a smaller concave surface 54 area than the cradles 14, 16. The tighteners 50, 52 of the lower tool set 48 may have the same patterned surface and operation of the upper tool set 12. In a preferred embodiment the back tightener 50 and front tightener 52 move simultaneously to close around the partially compressed stock 20. A small pin 56 is preferably attached on the upper surface of the back tightener 50. The small pin 56 may alternatively be attached to the front tightener 52. In one embodiment, the small pin 56 has a smaller diameter than that of the large pin 18. In some embodiments, the diameter of the small pin 56 may be equal to that of the large pin 18. The tighteners 50, 52 further compress the partially compressed stock 20 to a fully compressed state thus creating a final product. In the disclosed embodiment, the ends 32 of the fully compressed stock 20 partially overlap to form a complete circle. In other embodiments, the ends 32 of the fully compressed stock 20 may not overlap at all. In other embodiments, more than two tool sets 12, 48 may be used to create a final product.

FIG. 6 is a side view of the embodiment of FIG. 5. Below the small pin 56 lies a support surface 60, that may be bolted to a table. After the partially compressed stock 20 is completely compressed around the small pin 56, it becomes a fully compressed stock 20 which substantially encloses the small pin 56. The small pin 56 may be connected to the back tightener 50 such that the back tightener 50 is able to pull the small pin 56 laterally away from the large pin 18 and the support surface 60. The back tightener 50 preferably pulls the small pin 56 away from the support surface 60 by holding an upper portion 62 of the small pin 56. The upper portion 62 of the small pin 56 preferably lies above the upper edge 64 of the fully compressed stock 20. As the small pin 56 is moved away from the large pin 18 and the support surface 60, the fully compressed stock 20 is able to drop from the small pin 56 and into a supply bucket or other suitable receptacle below (not shown) for holding completed products. Alternatively, ejectors may be used as described above to cause the stock 20 to descend from the small pin 56.

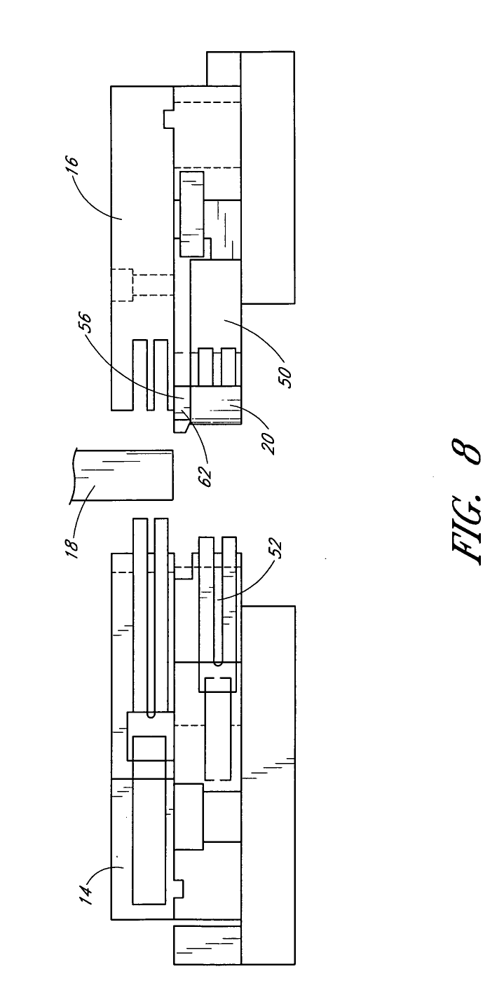

FIG. 7 shows an overhead view of a fourslide device 10. The fourslide device 10 is comprised of an upper tool set 12, a left slide 40, a right slide 42, and a lower tool set 48 operating in combination with each other. In this embodiment, the upper tools 12 are located directly above the lower tools 48 while the slides 40, 42 are stationed approximately perpendicular to and on the same level as the lower tools 48. In other embodiments, the upper and lower tools 12, 48 may not be in direct alignment with each other. Further, in some embodiments, the slides 40, 42 may not lie perpendicular to or on the same level as the lower tools 48. Some embodiments may use more than two levels. For example, one embodiment may have a third level consisting of another nesting level or another set of tools.

FIG. 8 is a side view of the embodiment of FIG. 7 (support surface 60 not shown). The upper tool set 12 is located above the lower tool set 48.

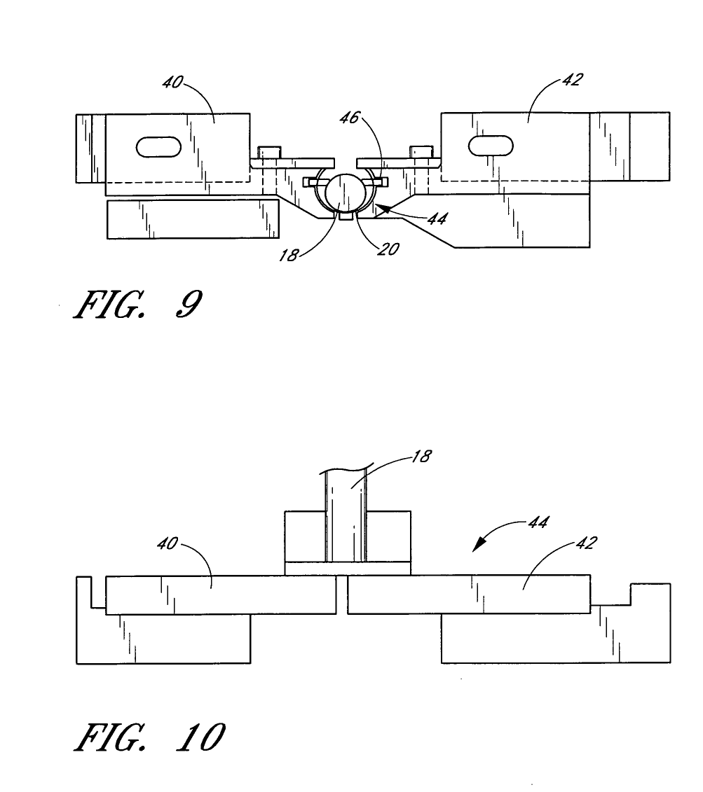

FIG. 9 shows an overhead view of the left slide 40 and the right slide 42. In one embodiment the partially compressed stock 34 is formed around the large pin 18. When the pressure pin 36 (not shown) retracts from the partially compressed stock 34, one or more ejectors 46 descend down the large pin 18 to force the partially compressed stock 34 into the nest 44 below. In one embodiment three ejectors are used to position the partially compressed stock 34 securely in the nest 44.

FIG. 10 shows a side view of the embodiment shown in FIG. 9.

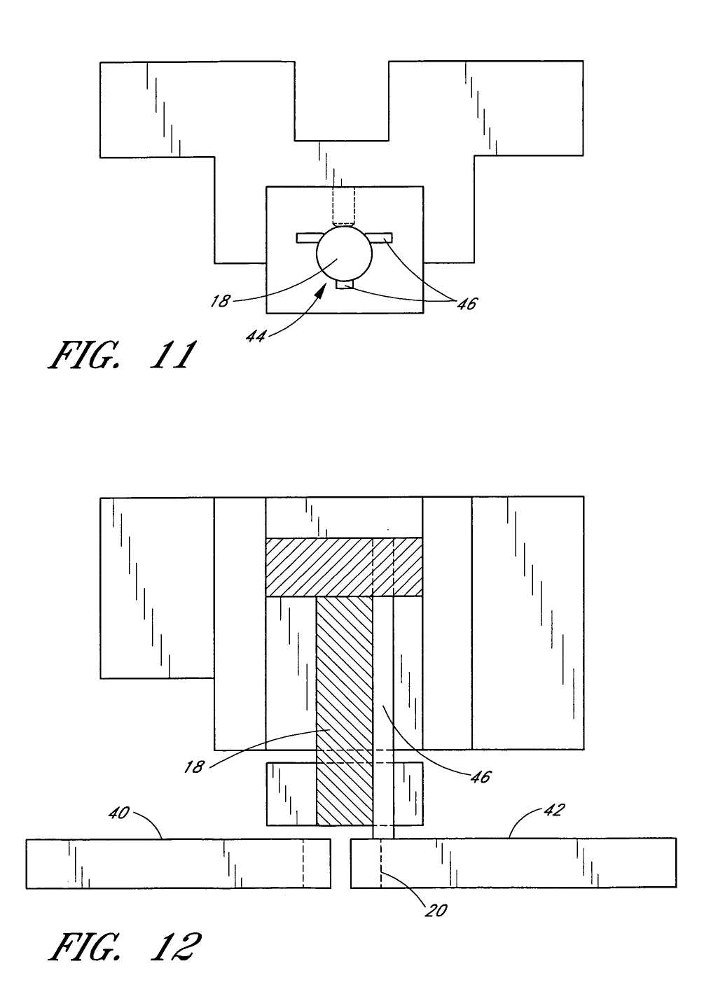

FIG. 11 shows an overhead view of an embodiment of a large pin 18 having a plurality of ejectors 46 for forcing the partially compressed stock 20 off of the large pin 18 and into the nest 44 below (not shown).

FIG. 12 is a side view of the embodiment show in FIG. 11. An ejector 46 is shown contacting an edge of the partially formed stock 20 to force it off of the large pin 18.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of skill in the art based upon this disclosure. It is also contemplated that various combination or subcombinations of the specific features and aspects of the embodiments may be made and still fall within the scope of the invention. Accordingly, it should be understood that various features and aspects of the disclosed embodiments can be combined with or substituted for one another in order to form varying modes of the disclosed invention. Thus, it is intended that the scope of the present invention herein disclosed should not be limited by the particular disclosed embodiments described above.

1. A method of making a metallic ring, comprising:
inserting a strip of metal into a first portion of a machine;
shaping the strip around a first pin having a first diameter;
moving the shaped strip automatically to a second portion of the machine;
shaping the strip around a second pin having a second diameter smaller than the first diameter to form a ring; and
releasing the ring from the machine.

2. The method of claim 1, wherein the second portion is below the first portion.

3. The method of claim 1, wherein the strip is moved from the first portion to the second portion by sliding the strip down the first pin having a first diameter.

4. The method of claim 1, wherein the strip is shaped around the pins of each portion by sliding components that press the strip between surfaces of the sliding components and the pin.

5. The method of claim 4, wherein the sliding components form part of a four slide device.

6. A machine adapted to perform the method of claim 1.

7. A method for manufacturing a tolerance ring, comprising:
placing a piece of metal stock having two ends adjacent a concave surface of a front cradle of an upper tool set;
moving the front cradle in the direction of a back cradle so that the metal stock at least partially compresses around a large pin, the large pin being located intermediate the front cradle and the back cradle in the upper tool set;
moving the back cradle in the direction of the front cradle such that a substantially tight fit is formed between the front cradle and back cradle, wherein the metal stock is compressed around the large pin, the piece of metal stock being formed into an at least partially compressed state;
releasing compression around the large pin by moving the back cradle and front cradle in opposite directions to their original positions, while simultaneously a pressure pin makes contact with the piece of metal stock and maintains the metal stock in a fixed location on the large pin;
moving a left nesting slide and a right nesting slide in a direction approximately perpendicular to the direction traversed by the front cradle and back cradle, such that the left nesting slide and right nesting slide contact each other and close to form a nest at a vertical level below the level of the location of the upper tool set;
retracting the pressure pin from the metal stock and the large pin;
moving the partially compressed stock vertically downward, by use of ejectors, and into the nest below formed by the left nesting slide and the right nesting slide;
moving a front tightener and a back tightener, of a lower tool set, towards each other to come in contact with the partially compressed stock;
compressing the partially compressed stock, by use of the front tightener and the back tightener, around a relatively smaller pin than the large pin, the smaller pin connected to the back tightener, such that the partially compressed stock is compressed to a fully compressed state, wherein the two ends of the fully compressed stock partially overlap to form a complete circular shape;
moving the smaller pin in a horizontal direction away from the front tightener; and
dropping the fully compressed stock from the small pin to a receptacle located below the lower tool set.

8. The method of claim 7, wherein the metal stock is compressed around the large pin at an exerted pressure within the range of about 19 lbs. per square inch to 90 lbs. per square inch

9. The method of claim 7, wherein the metal stock has a plurality of dimples or bumps.

10. The method of claim 7, wherein the large pin has a plurality of dimples or bumps on its outer surface.

11. The method of claim 7, wherein the front and back cradle compress around the stock simultaneously.

12. The method of claim 7, wherein the front and back tighteners move simultaneously to come into contact with the partially compressed stock.

13. A method of forming a stock material, comprising:
moving a front cradle and a back cradle of a first tool set to compress a piece of stock material around a large pin, the large pin located intermediate the front cradle and the back cradle, wherein the stock material forms an at least partially circular shape and is in a partially compressed state;
automatically moving the partially compressed stock to a location between a front tightener and a back tightener of a second tool set;
compressing the partially compressed stock around a small pin with the front and back tighteners, the stock material forming a complete circular shape and being in a fully compressed state; and
releasing the fully compressed stock from the small pin.

14. The method of claim 13, wherein the stock material is metal.

15. The method of claim 13, wherein the stock material has a plurality of dimples or bumps.

16. The method of claim 13, wherein the large pin has a plurality of dimples or bumps on its outer surface.

17. The method of claim 13, further comprising compressing the stock around the large pin at an exerted pressure within the range of about 19 lbs. per square inch to 90 lbs. per square inch.

18. The method of claim 13, further comprising compressing the stock around the large pin at an exerted pressure of approximately 50 lbs. per square inch.

19. The method of claim 13, further comprising moving the partially compressed stock vertically downward between the first and second tool set.

20. A tolerance ring, formed by the method of claim 13.

21. An apparatus for forming a piece of material, comprising:
an upper tool set, movable in a horizontal forward and backward direction, comprising a front cradle and a back cradle adapted to compress the piece of material around a large pin;
a nest, movable in a horizontal left and right direction, comprising a left nesting slide and a right nesting slide, wherein the nest is located at a vertical level below the upper tool set; and
a lower tool set, movable in a horizontal forward and backward direction, comprising a front tightener and a back tightener, wherein the lower tool set is at a vertical level below the nest and the nesting slides are approximately perpendicular to the lower tool set, wherein the front and back tighteners are adapted to compress around a small pin, the small pin being smaller than the large pin.

22. The apparatus of claim 21, wherein the front and back cradle and the front and back tightener follow the same horizontal path.

23. The apparatus of claim 21, further comprising a pressure pin for holding the piece of material at a substantially fixed location on the large pin when the front cradle and back cradle are released from compression around the large pin.

24. The apparatus of claim 21, further comprising ejectors for release the piece of material from the large pin upon the pressure pin being released from the large pin.

25. The apparatus of claim 21, wherein the front cradle and the back cradle of the upper tool set each have a concave surface such that a substantially tight fit is formed when the front cradle and back cradle close around the large pin.

26. The apparatus of claim 21, wherein the lower tool set is located at a vertical level approximately directly below the upper tool set, such that the front tightener is located approximately directly below the front cradle and the back tightener is located approximately directly below the back cradle.
